(19) United States
(12) Patent Application Publication
(10) Pub. No.: US 2008/0211427 A1
(43) Pub. Date: Sep. 4, 2008

(54) Lighting System and Method for Controlling a Lighting System

(75) Inventors: Wolfgang Budde, Aachen (DE); Armand Michel, Marie Lelkens, Heerlen (NL); Erdmann Bozena, Aachen (DE); Oliver Schreyer, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,637

(22) PCT Filed: May 22, 2006
(86) PCT No.: PCT/IB2006/051620

§ 371 Date: Nov. 27, 2007

(30) Foreign Application Priority Data
Jun. 2, 2005 (EP) 05104793.4

(51) Int. Cl. H05B 41/36; G08C 19/00

(52) U.S. Cl. 315/294; 340/825.69

(57) ABSTRACT

A lighting system with a base station and a plurality of lighting units, as well as a method for controlling a lighting system are described. Each lighting unit (12) has a light source (14), a controller unit (18) and associated configuration data. A receiver (20) receives control commands over a medium shared by the lighting units (12), e.g. wireless. A base station (10) comprises a configuration memory unit (34) to store configuration data. A central processing unit (24) uses a transmitter (38) to transmit control commands to the lighting units (12). The lighting units (12) are addressed using data stored in the configuration memory unit. The lighting units (12) are operated sequentially.

The present invention relates to a lighting system, a base station and a lighting unit for use in a lighting system and a method for controlling a lighting system.

Lighting systems including a plurality of spatially distributed light sources are known. An example of a known lighting system is given in WO-A-2004/100618. Here, light sources are connected to ballasts which are controlled over wire by a master lighting control unit using the DALI (digital addressable lighting interface) standard. The ballasts comprise an infrared receiver which may be used for programming a device or group address. An infrared transmitter transmits the address, and possibly other commands, to the ballasts. During operation, the control unit may now address the ballast over the DALI wire interface using the programmed address.

U.S. Pat. No. 6,739,966 shows a lighting system with a plurality of lighting units with light sources which are controlled by a wireless remote control device. During setup, the individual lighting units are programmed with serial codes and zone codes, which are entered via a keyboard at the remote control module and transmitted over the wireless link. During operation, the remote control unit can uniquely address the lighting unit by the serial code to control the on or off state of the light sources.

Generally, if a plurality of lighting units are simultaneously connected to a control unit over a shared medium, individual control of the units is only possible if the communication link provides some type of address. The lighting units may then be controlled sequentially, so that their respective light sources are activated according to a predetermined sequence.

It is the object of the present invention to provide a lighting system, a base station, a lighting unit for use in such a system, and a method for controlling the system providing convenient configuration and flexible operation.

This object is solved by a lighting system according to claim 1, a base station according to claim 10, a lighting unit according to claim 11, and a method according to claim 12. Dependent claims refer to preferred embodiments of the invention.

A lighting system according to the invention includes a base station and a plurality of lighting units. Each lighting unit comprises at least one light source. The light source may be of any type, e.g. incandescent, fluorescent tube, arc, or LED. A lighting unit may also have a plurality of light sources, e.g. of different colour. Each lighting unit has a controller unit configured to control the light source. Controlling the light source may comprise turning the light source on or off as well as changing the intensity and/or colour of the light source, etc.

A data reception means is provided, such that control commands may be received over a medium shared by the lighting units, according to which the controller unit may then control the light source. The shared medium may be a wire, e.g. powerline data transmission over a wire link shared by the lighting units or a wired data network. Preferably, the medium is wireless. In this case, the wireless reception means may be of different type, e.g. infrared, but is preferably a radio receiver. Most preferably, communication according to IEEE 802.15.4 (ZigBee) is used.

Each lighting unit has associated unit configuration data, which may be used to address the lighting unit on the shared medium. The unit configuration data is preferably an individual address, like a MAC-address. The unit configuration data may comprise further information e.g. details regarding the—preferably wireless—communication (e.g. channel, or key for encryption).

Further, the lighting system includes a base station. In the present context, this term is used for any type of controlling unit for the lighting system. The base station may be stationary, e.g. connected to mains power, but may also be mobile and/or battery operated.

The base station comprises a data transmission means compatible to the reception means in the lighting units, which may transmit data over the shared medium to the lighting units. A central processing unit is provided, which transmits control commands for the individual lighting units over the medium. The central processing unit thus remotely controls the light sources, e.g. by turning them on or off.

For the configuration of the lighting system, a configuration memory unit is provided, which is accessible from the central processing unit. In the configuration memory unit, unit configuration data of every lighting unit configured within the lighting system is stored. The configuration memory unit is writeable, so that during initial configuration the unit configuration data—e.g. MAC-address—of each configured lighting unit may be stored, and in the case of configuration changes data may be deleted and/or changed. Preferably, the configuration memory is organized according to the order in which the units were configured.

During operation of the lighting system, the central processing unit accesses the configuration memory unit and sends control commands to the lighting units, addressing them according to the individually stored unit configuration data. The central processing unit sends these control commands so that the lighting units (or, more specifically, the light sources of the lighting units) are operated in sequential manner. Such a sequence may be e.g. a one-by-one sequence, where light sources are only activated one after the other. However, such a sequence may also include more complex, time-variant driving patterns. In the present context, the term “sequence” is used for any time-variant operation of a group of light sources, where not all light sources are operated simultaneously.

The sequence according to which the lighting units are operated may be determined according to an application program.

The inventive lighting system and control method provide very flexible and easy configuration. Communication over a shared medium, especially wireless control allows great flexibility in placing the lighting units. A writeable, preferably non-volatile configuration memory unit in the base station flexibly allows configuration of lighting systems with very few, e.g. only two lighting units as well as of a high number of lighting units. Sequential operation of the lighting units allows for the whole system to display different time-variant patterns. If the lighting units are arranged to form a spatial distribution, e.g. a line or a matrix, moving light patterns may be displayed.

It should be emphasised that the above mentioned elements are the minimum requirements for the system according to the invention. Additional units may be present, and mentioned units may comprise additional capabilities. E.g., the receiving means may also be able to transmit data (e.g. acknowledge receipt of data), and the transmission means may correspondingly also receive data.

According to a further development of the invention, the base station comprises a base configuration interface to wirelessly read the unit configuration data. While alternatively the data my be read out over a direct connection, wireless reading especially simplifies configuration of the system. The base configuration interface is preferably a short-range wireless interface, i.e. it has shorter range than the wireless technology used for transmitting the control commands. Preferably, the range of the short-range wireless interface is less than 30 cm, most preferably less than 10 cm.

According to preferred embodiments, the base configuration interface may be either an RFID reader unit which reads unit configuration data stored in an RFID tag of the lighting unit, or a barcode reader which reads unit configuration data given as a barcode on the lighting units. In each case, the user may very easily configure a lighting unit by placing it within the range of the base configuration interface. The short range of the base configuration interface allows to unambiguously identify a single lighting unit placed within this range. The unit configuration data is then—possibly after activation of a configuration mode, e.g. via a special key—read out and stored in the configuration memory unit. Thus, configuration of the lighting unit is already completed. Reading pre-configured configuration data, instead of assigning newly chosen addresses as found in the prior art, can be effected automatically without user input.

According to a further preferred embodiment of the invention, the base station comprises a non-volatile application memory unit. Stored application programs provide different sequences of activation of the lighting units. The user may choose between different application programs using input means—e.g. keys—provided at the base station. The memory may be writable to change application programs.

The lighting units may receive their electrical operating power from a wire connection to a power supply. However, it is preferred that the lighting units comprise an energy storing unit delivering electrical energy. This may be a rechargeable or non-rechargeable battery, or a high capacity capacitor, which e.g. may be charged by solar cells. This way, placement of the units is even more flexible.

According to a preferred embodiment of the invention, distributed application programs are executed in the lighting units under control and/or synchronisation of the base station. The lighting units each comprise an application storage with at least one application program describing an activation sequence. Upon control—e.g. a start command—from the base station, the program is executed by the controller units of the lighting units. Command messages or periodic signalling messages (beacons) may be used to synchronise program execution in all lighting units.

In the following, preferred embodiments of the invention will be described with reference to the drawings, in which:

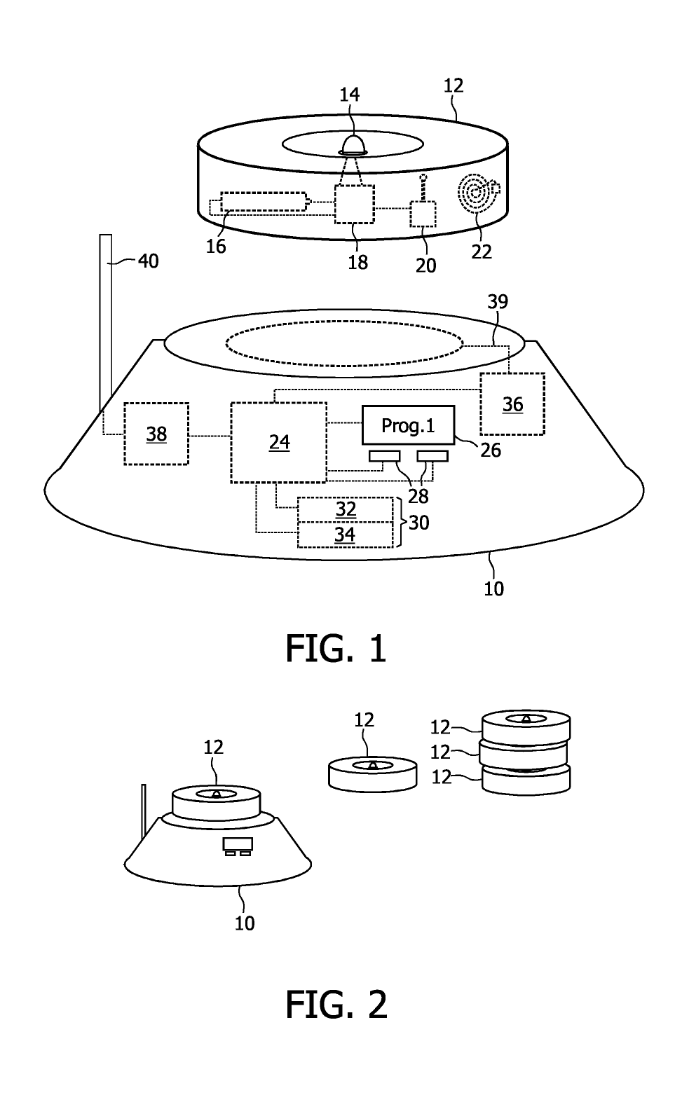

FIG. 1 shows a symbolic representation of a first embodiment of a base station and a lighting unit;

FIG. 2 shows a symbolic representation of the configuration of a lighting system;

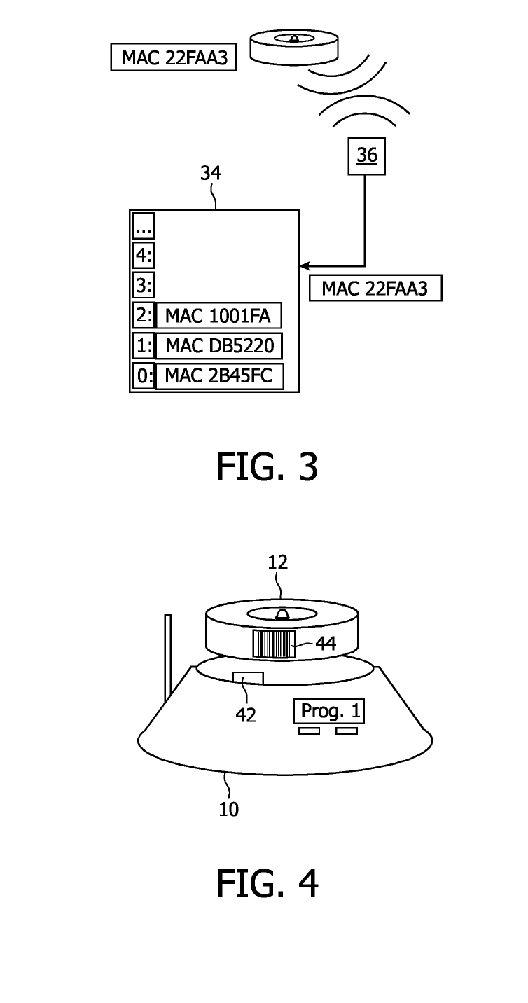

FIG. 3 shows a symbolic representation of the configuration of a lighting unit;

FIG. 4 shows a perspective view of a second embodiment of a base station and a lighting unit;

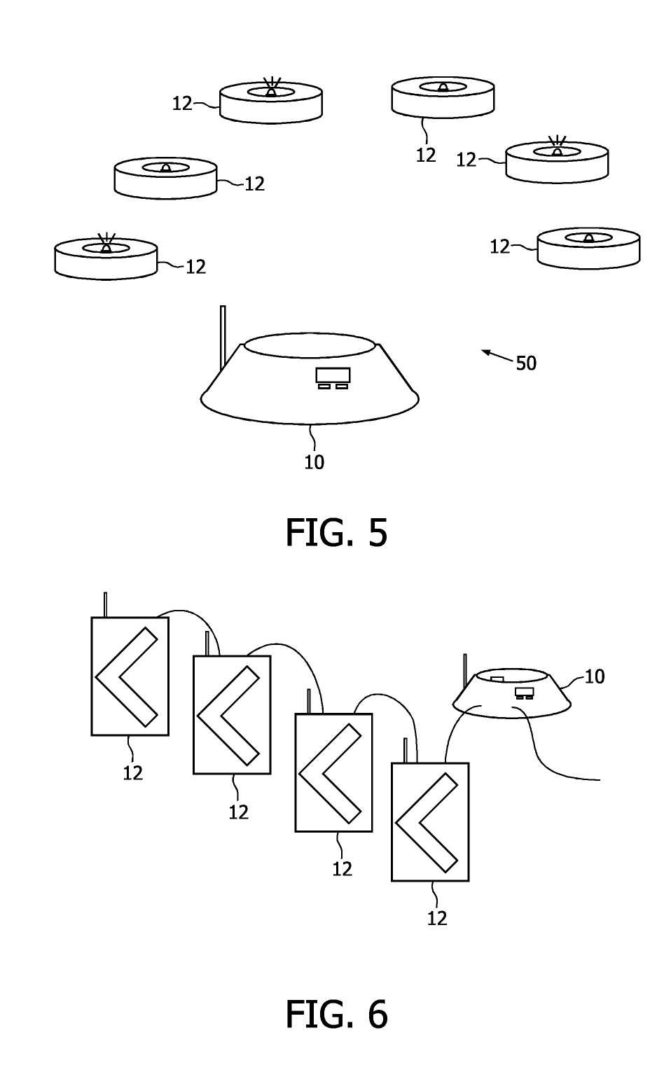

FIG. 5 shows a first example of a lighting system;

FIG. 6 shows a second example of a lighting system.

FIG. 1 shows in a perspective, partly symbolic representation a base station 10 and a lighting unit 12.

The lighting unit 12 comprises a light source, which in the present example is shown as an LED 14. Lighting unit 12 is powered by a battery 16. A controlling unit 18 controls operation of LED 14, i.e. switches the LED 14 on or off. An RF receiver unit 20 is provided, which in the present example is a wireless communication interface according to ZigBee (IEEE 802.15.4 standard).

The ZigBee interface 20 has a unique device address (MAC-address). This MAC-address is also separately stored in an RFID tag 22. RFID technology is known per se to the skilled person, so that RFID tag 22 shown only symbolically in FIG. 1 need not be explained in detail. RFID tag 22 comprises an antenna so that it may be activated by R.F. electromagnetic energy of a predetermined frequency. RFID tag 22 operates passively by using the energy from the activating field to wirelessly transmit the MAC-address upon query.

Base station 10 comprises a central processing unit 24—typically a microprocessor—connected to all functional parts thereof. The unit further comprises a display 26, keys 28, and a writeable, non-volatile memory unit 30 comprising a program memory 32 for storing application programs and memory space 34 serving as configuration memory. An RFID reader unit 36 with an RFID antenna 39 is provided and connected to the central processing unit 24. An RF transmitter 38 operating according to ZigBee is provided together with an antenna 40.

A lighting system 50, as shown in FIG. 5, comprises a base station 10 and a plurality of lighting units 12 as described above. The system may be configured as follows:

During initial setup, configuration memory 34 of base station 10 is empty. As shown in FIG. 2, a number of lighting units 12 are provided. For configuration, the lighting units 12 are powered and individually placed onto the base station 10. On power-up, the lighting units automatically enter a configuration mode.

As soon as a first lighting unit 12 is placed on base station 10, RFID reader 36 transmits a query via antenna 38, and receives in response from RFID tag 22 the MAC-address of the lighting unit 12. The corresponding situation is shown in FIG. 3. The received MAC-address is stored in configuration memory 34.

The base station 12 then sends a configuration packet to the MAC-address of the lighting unit 12 presently under configuration via the wireless communications interface 38. In the present case of a ZigBee communication, the transmission may be made over several channels consecutively until the lighting unit 12 listens to the proper channel. Alternatively, the preferred channel may be stored in the RFID tag and read out together with the MAC address. The configuration packet includes a unique network identifier selected by the base station 12 (e.g. in case of ZigBee communication: 16-Bit PAN identifier) and the communication channel to be used for normal operation. A further part of the configuration packet is a unique application-level identifier (APPID) to the lighting unit 12. This APPID is related to the order in which the lighting units 12 are configured. As shown in FIG. 3, the first lighting unit receives APPID # 0, the second # 1 etc.

After the first lighting unit 12 is configured as described above, the base station 10 may start sending out a beacon signal via its wireless communication interface 38, using an multicast or broadcast address covering all currently configured lighting units 12 in the network. This beacon serves as a synchronisation pattern, indicating the start of an application cycle (and carries information about beacon interval duration, to allow the devices to put the wireless interface to sleep, to conserve power). Most applications will be organized in cycles, which can be executed once or several times.

In a further step, a further lighting unit 12 is placed on base station 10 and configured as described above. This step is repeated for every further lighting unit to be configured. After every successful configuration, the base station 12 may adapt its beacon interval, allowing for time windows as specified by the application for every lighting unit participating in the application.

The user places the configured lighting unit 12 according to a desired spatial configuration. An example is shown in FIG. 5, where the lighting units 12 are arranged in a half circle, within the range of the ZigBee network.

The user then uses keys 28 to select an application program as stored in program memory 32. User feedback is given via display 26. The user may then start the selected application program, e.g. using one of keys 28.

As the application program is executed by central processing unit 24 of base station 10, control commands are sent over the ZigBee network to the individual lighting units 12. The control commands are directed at the lighting units 12 by means of their MAC-addresses. The lighting units 12 receive the control commands and operate their light sources 14 accordingly. The application program determines the sequence according to which the lighting units 12 are operated, i.e. when individual light sources 14 should be active.

There are obviously numerous possibilities for sequences according to which lighting units 12 may be operated. These sequences, and corresponding application programs, produce a moving lighting pattern in conjunction with the spatial arrangement of the lighting units 12. For example, the lighting units 12 may be placed in the shape of a chain. The application program may then determine that the light sources should be operated as a running light, where one or several, active light sources “move” along the chain.

Other examples for application programs—and corresponding sequences—include alternate operation of the lighting units (e.g. every other lighting unit is alternately activated). With different spatial configuration of the lighting units, other pattern effects may be achieved. For example, the lighting units may be placed in a 2D matrix, so that moving 2D images (of coarse resolution) or patterns may be displayed. Special spatial arrangements may correspond to associated application programs. The user may, for example, learn from a system manual that placing lighting units 12 in a 4×4 matrix and activating a corresponding program will display an image of a moving bar.

Possible applications of the described lighting system are on one hand decorative lighting, e.g. at home. Other applications comprise advertising, where special optical effects may be helpful.

Another application, shown in FIG. 6, is traffic signalling. Here, lighting units 12 have a light source in the shape of an arrow, e.g. a plurality of LED's arranged in an arrow-shaped pattern. The individual lighting units 12 in this example are each connected by wire to a power supply (not shown). Control is effected over powerline communication from base station 10, which in this example will be equipped with a corresponding powerline interface. Powerline communication using modulation of higher frequency signals over the low frequency alternating supply voltage is known per se to the skilled person and will thus not be further explained. The common power connection in this example serves as the shared medium, where addressing is done as described in the above example.

During operation of the lighting system shown in FIG. 6, lighting units 12 are operated in sequential manner to show an arrow moving from right to left. In this way, signalling is provided, e.g. for traffic, or in emergency situations.

There are several modifications possible to the above given examples:
Instead of an RFID-reader, the base station 10 may comprise a barcode reader 42 as shown in FIG. 4. A barcode label 44 is attached to the lighting units 12 which contains the MAC-address. The base station 10 may thus read out the MAC-address and otherwise perform the configuration step as described above.
As a further alternative for the configuration interface, infrared communication with low transmit power (and optionally mechanically aligned IR diodes to limit the communication area to exactly the lighting unit placed in the vicinity of the base station) may be used.
As another possible modification, the wireless communication may be encrypted. An individual key of encryption of the initial communication between base station 10 an lighting unit 12 may be included in the RFID tag 22 or barcode label 44, as well as into the wireless interface 20 of the lighting unit 12.
Base station 10 and/or lighting units 12 may comprise additional input means e.g. power-on switches etc. to switch the devices on or off, to activate configuration mode etc. The lighting units 12 may use there light source 14 to display status information, e.g. by flashing at a predetermined rate.
The base station 10 may be connected to a personal computer (or comparable device) to upload and modify application programs, etc. The connection may be e.g. a USB interface.
Lighting units, which in the above examples are always shown as being identical, may be of different types. The lighting units 12 may announce their capabilities to the base station 10 during the initial configuration phase. This would require standardization of the announcement messages, similar to the UPnP service descriptions.
Additionally to application programs which operate the lighting units 12 sequentially, the base station may also comprise application programs which operate all lighting units 12 identically at the same time (e.g. “continues on”, “common-mode dimming”, or “common-mode colour change”).
As a further alternative, application programs may also reside in the lighting units 12. The execution of these distributed programs may then be effected under control and in synchronisation to base station 10.
Configuration memory 34 which in the above example has been described as a non-volatile memory may also be volatile, e.g. RAM memory. However, then all configuration data would be lost each time the base station 10 is powered off.
Base station 10 may alternatively be shaped as an elongated rod, to be used as a “magic wand” which configures lighting units 12 by touching them or pointing at them.

The above described features of individual examples, as well as the further described modifications, may be combined as desirable for a given application. In summary, the above described lighting system is easily and flexibly configurable and allows complex sequential operation of distributed light sources.

1-12. (canceled)

13. Lighting system including
a base station (10) and
a plurality of lighting units (12)
where said lighting units (12) each comprise at least
unit configuration data associated with said lighting unit (12)
a light source (14)
an application program storage with at least a stored program describing an operation sequence of the light source,
a controller unit (18) configured to control said light source (14) according to the stored program under control and/or synchronisation of control commands,
and a data reception means (20) configured to receive the control commands for said controller unit (18) over a medium which is shared by all lighting units (12),
and where said base station (10) comprises at least
a data transmission means (38) configured to transmit the control commands to said data reception means (20) over said shared medium,
a configuration memory unit (34) to store said unit configuration data,
and a central processing unit (24) configured to drive said data transmission means (38) to transmit control commands to sequentially drive said lighting units (12), where said lighting units (12) are addressed using data stored in said configuration memory unit (34).

14. System according to claim 13, where
said data reception means (20) and said data transmission means (38) are configured to communicate over a wireless medium.

15. System according to claim 13, where
said base station (10) further comprises a base configuration interface (36, 42) configured to wirelessly read said unit configuration data from said lighting units (12).

16. System according to claim 15, where
said base configuration interface (36, 42) is a short range wireless interface.

17. System according to claim 16, where
said lighting units (12) each further comprise an RFID tag (22) containing said unit configuration data,
and said base station (10) further comprises an RFID reader unit (36) to read said RFID tag (22).

18. System according to claim 16, where
said lighting units (12) each further comprise a barcode (44) containing said unit configuration data,
and said base station (10) further comprises a barcode reader unit (42) to read said barcode (44).

19. System according to claim 13, where
said base station (10) further comprises
a non-volatile application memory unit (32) storing at least a plurality of application programs, said application programs each describing an operation sequence of said lighting units (12)
and input means (28) configured to choose between said application programs.

20. System according to claim 13, where
said lighting units (12) further comprise an energy storing unit (16) configured to deliver electrical energy.

21. Base station for use in a system according to claim 13, comprising at least
a data transmission means (38) configured to transmit control commands
a configuration memory unit (34) to store unit configuration data,
and a central processing unit (24) configured to drive said data transmission means (30) to transmit control commands to sequentially drive lighting units (12), where said lighting units (12) are addressed using data stored in said configuration memory unit.

22. Lighting unit for use in a system according to claim 13, comprising at least
means for storing configuration data, where said data may be read out by a wireless interface,
a light source (14),
an application program storage with at least a stored program describing an operation sequence of the light source,
a controller unit (12) configured to control said light source (14) according to the stored program under control and/or synchronisation of control commands,
and a data reception means (20) configured to receive the control commands for said controller unit (12).

23. Method for controlling a system comprising a base station (10) and a plurality of lighting units (12), where
in a configuration step, unit configuration data associated with each of said lighting units (12) is stored in said base station (10),
and during operation, said base station (10) sends control commands over a medium shared by said lighting units (12), which control commands are addressed to said lighting units (12) using said configuration data,
and said lighting units (12) each receive said control commands and control a light source (14) according to a program, stored in an application storage of the lighting unit (12), under control and/Or synchronisation of said control commands,
such that said light sources (14) are driven sequentially.
